(19) United States
(12) Patent Application Publication
(10) Pub. No.: US 2013/0088386 A1
(43) Pub. Date: Apr. 11, 2013

(54) Satellite shoe with global positioning system

(71) Applicant: Sanjay Goswami, Sugarland, TX (US)

(72) Inventor: Sanjay Goswami, Sugarland, TX (US)

(73) Assignee: SANJAY GOSWAMI

(21) Appl. No.: 13/068,582

(22) Filed: Oct. 6, 2011

(51) Int. Cl. G01S 19/17; G01S 19/42

(52) U.S. Cl. 342/357.55; 342/357.25

(57) ABSTRACT

This is a specially designed shoe fitted with a GPS chip to track the movement and location of the persons wearing it. The chip is hidden in a separate compartment in the sole of the shoe. The chip is powered by a long-life battery and could be recharged from time to time. The chip emits signals to the wireless tower and subsequently picked up by the satellite, which in turn sends the exact location information of the chip via cyberspace in the home computer. A map is displayed in the computer showing the approximate location of the chip with a coded number within 20-30 yards of the pointer. The shoe is primarily invented to track the missing children and elderly people with Alzheimer. According to U.S. Department of Justice, 797,500 children get missing every year in the United States. The purpose of this invention is to track these missing children by a sophisticated device that never existed before.

### INTRODUCTION

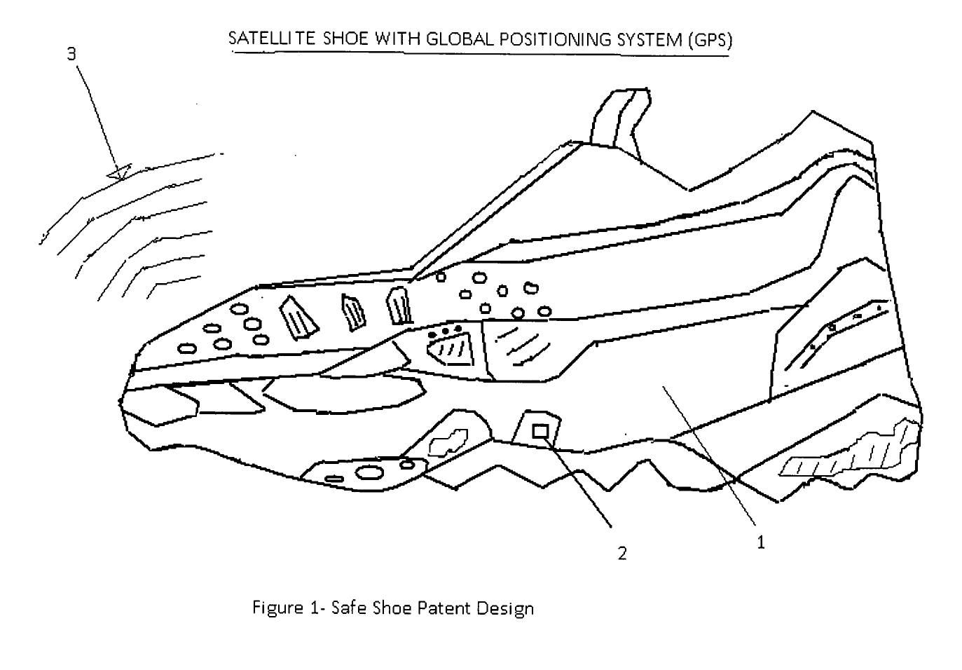

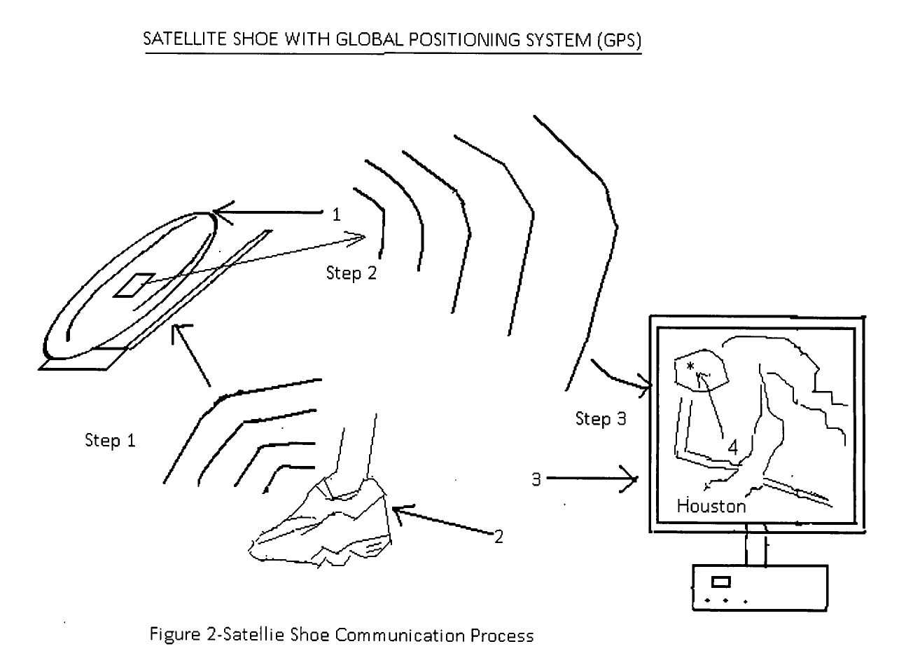

This is a a project to invent a shoe which will track down the missing children and senior citizens with dementias or Alzheimer disease with the help of a miniature Global Positioning Sytem(GPS) inserted secretly into the sole of the shoe normally worn by the children or elderly people. Today, millions of children go missing or kidnapped from schools, shopping malls and other places. This device will minimize those occurrences. Secret code number will be assigned to each chip and will be residing in a data base, operated by a private security data system which will be in turn connected to the Global Satellite System. This chip (GPS tracker) will emit coded radio frequency at regular intervals to be tracked by the satellites orbiting the earth, which will in turn send the coded information about the position, co-ordinates, location map etc. in the computer via internet to the central security center. This chip will be very small (about 3″×2″×1″), operated by long life rechargeable battery and removable at any time from the shoe worn. The shoe will be also designed such a way that it has a small hidden slot under the sole where the chip could be secretly implanted, locked, taken out and reinserted. The chip could be implanted also in a new shoe if the old shoe is worn out. This way one can eliminate the risk of unnecessary surgery and complication of implanting the chi under one's skin. Satellite shoe will be real handy, reusable and yet it will provide all the securities and protections the children and elderlies will need in today's vulnerable society. A schematic diagram of the shoe and how it will operate is shown in FIG. 1 and FIG. 2 of page 2 and page 4 respectively.

### BRIEF DESCRIPTION OF THE INVENTION

The newly executed description substitutes the previous one. Specification contains no new matter.

The invention consists of three basic parts:
1) Specific design of the shoe
2) GPS chip for tracking
3) Monitoring System
1) The shoe may come in different sizes depending on the size of the foot of the person wearing it. it. It should be light weight jogging or running shoe like Nike or Rebok. But it is specially designed with at least 1.2 inches of thick sole with a hidden groove inside to accommodate the 0.75″ chip. The chip is itself very light-weight and can be inserted into the groove with a Velcro covering it and transparent cover to transmit and receive signals to and from the satellites.

2) The GPS chip is a standard chip obtained from any vendor. The chip is activated by a long-life power cell. The approximate time to charge the chip initially is 6 hours. After the chip is charged it can emit signals continuously for a week before recharging. It can also run by car charger or battery.

3) The monitoring system consists of a computer and wireless technology. The Google Earth Map will be very helpful in tracking the location of the chip

The schematic diagram of the shoe and operation is shown in FIG. 1 and FIG. 2.

### Legend for FIG. 1-Safe Shoe Patent Design

| Indices | Description |
|---|---|
| 1 | Satellite Shoe |
| 2 | GPS Chip hidden inside the shoe |
| 3 | Outgoing Signals from the GPS Chip |

### Legend for FIG. 2-Satellite Shoe ommunication Process

| Indices | Description |
|---|---|
| 1 | Satellite |
| 2 | Satellite Shoe |
| 3 | Home Personal Computer |
| 4 | *- Location of the shoe in Google Map |
| Step 1 | Outgoing signals from the shoe to the satellite |
| Step 2 | Outgoing signals from the satellite to PC |
| Step 3 | PC receives the signals and displays in the monitor n |

1: New technology
The technology of this invention is totally new and combines three elements
1) A tracking shoe with GPS chip.
2) GPS and Wireless technology of communication and tracking
3) PC technology, Mapping software
All these three elements combined make the tracking very powerful and innovative, which no one else has been able to come up with so far. The schematic diagram of how it works is shown in page 5. This technology is also very inexpensive, yet so potent that it should be deployed without any delay to avert the missing of so many children annually.

2: Specific design of the shoe.
The specific design of the shoe with thick sole to incorporate a special light-weight GPS chip is the key to this invention and is shown in FIG. 1 of page 3 of this invention. The design of the shoe is unique with a special compartment in the heel to house the GPS chip. No one has come up with such a design yet and is considered original as a dependent claim on the primary claim number 1.
